(19) United States
(12) Patent Application Publication
(10) Pub. No.: US 2009/0073241 A1
(43) Pub. Date: Mar. 19, 2009

(54) Inkjet head and manufacturing method of the same

(75) Inventors: Won-Chul Sim, Seongnam-si (KR); Jae-Woo Joung, Suwon-si (KR); Young-Jae Kim, Suwon-si (KR); Chang-Sung Park, Suwon-si (KR); Young-Seuck Yoo, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/068,565

(22) Filed: Feb. 7, 2008

(30) Foreign Application Priority Data
Sep. 18, 2007 (KR) 10-2007-0094937

(51) Int. Cl. B41J 2/045; G11B 5/127

(52) U.S. Cl. 347/68; 216/27

(57) ABSTRACT

A method of manufacturing an inkjet head that includes: forming in a first board an inlet, which penetrates the first board and through which ink may flow in, and a pressure chamber, which is formed as a recess in a surface of the first board; forming in a second board a manifold, which is to be connected with the inlet, a pressure absorbing space, which is positioned adjacent to the manifold and partitioned by a membrane, and an ink channel, which penetrates the second board and which is to be connected with the pressure chamber; forming in a third board a nozzle, which is to be connected with the ink channel; and stacking in order and attaching the first board, the second board, and the third board. This method can be utilized to simplify the manufacturing process and prevent crosstalk between pressure chambers, thereby providing a higher printing quality.

### CROSS-REFERENCE TO RELATED APPLICATIONS

This application claims the benefit of Korean Patent Application No. 10-2007-0094937 filed with the Korean Intellectual Property Office on Sep. 18, 2007, the disclosure of which is incorporated herein by reference in its entirety.

### BACKGROUND

1. Technical Field

The present invention relates to an inkjet head and a method of manufacturing the inkjet head.

2. Description of the Related Art

Inkjet printing technology has been used mainly in the field of OA (office automation), as well as in industrial fields such as for package marking and printing on clothing. However, with developments in functional ink which includes metal nanoparticles of silver and nickel, etc., the potential applicability of inkjet-printing technology is gradually expanding. Current applications of inkjet printing thus include forming circuit patterns in printed circuit boards using functional ink that contains metal nanoparticles.

Continuous developments are currently being made in techniques involving inkjet printing, and in the electronics industry, methods are being studied of utilizing inkjet printing in the manufacture of color filters in liquid crystal displays, and printed circuit boards (PCB's), etc. In contrast to the inkjet technology in the office environment, inkjet methods for industrial use require the operation of all of the multitude of nozzles, formed in the inkjet head in numbers of 128 or 256, etc.

The structure of a typical inkjet head includes a pressure chamber which carries the ink and pressurizes the ink according to changes in its volume, a nozzle connected to a portion of the pressure chamber, a manifold connected to another portion of the pressure chamber which stores the ink supplied to the pressure chamber, and an ink inlet through which ink is supplied to the manifold.

The ink supplied through the ink inlet passes through the manifold and into the pressure chamber, and the ink pressurized in the pressure chamber is ejected out through the nozzle. A piezoelectric component, such as an actuator, etc., is coupled to the pressure chamber to change the volume of the pressure chamber, whereby the ink carried in the pressure chamber can be pressurized.

Many pressure chambers are connected to a single manifold, and when the volume of each pressure chamber is reduced, ink is ejected through the nozzle, while at the same time ink flows back towards the manifold. This backflow of ink can cause a non-uniform increase in the pressure inside the manifold. Also, when the volume of the pressure chamber returns to its initial state, the ink flows again from the manifold to the pressure chamber, causing a non-uniform decrease in the pressure inside the manifold. When ink is ejected as such through many nozzles, the pressure inside the manifold increases or decreases rapidly in a non-uniform manner, which affects the adjacent pressure chambers. This is referred to as an occurrence of “crosstalk.” Crosstalk can alter the ejection speed or the volume of an ink droplet ejected from a nozzle, which makes it difficult to obtain a consistent printing quality.

FIG. 1 is a cross-sectional view of an inkjet head according to the related art. Ink may flow from the reservoir for supplying ink to the inkjet head, through the inlet 102, and into the manifold 104, and the ink directed into the manifold 104 may be supplied to the pressure chamber 106.

A single manifold 104 may be connected to many pressure chambers 106. When the volume inside a pressure chamber 106 is decreased by the vibration of the piezoelectric component 112 on top, the ink within the pressure chamber 106 is ejected past an ink channel 108 through the nozzle 110, while at the same time some of the ink flows back into manifold 104, and when the pressure chamber 106 is returned to its original state, the ink inside the manifold 104 flows into the pressure chamber 106 again and fills the pressure chamber 106. The non-uniform pressure caused by such inflow and outflow of ink to and from the manifold 104 can lead to crosstalk between pressure chambers 106, so that it is difficult to obtain a consistent printing quality.

In order to prevent such crosstalk, in related art, an elastic membrane 114 is attached to an upper portion of the manifold 104 and a pressure absorbing space 116 is prepared over the elastic membrane 114, so that the pressure caused by the inflow and outflow of ink inside the manifold 104 may be absorbed and crosstalk may be avoided.

However, the inkjet head according to prior art cannot absorb the pressure changes caused by the backflow of ink from the pressure chamber 106 with great effectiveness, as the pressure absorbing space 116 is prepared above the manifold 104.

Also, forming the pressure absorbing space 116 requires a complicated manufacturing process, as the method of forming the pressure absorbing space 116 may include, at least, first forming the manifold 104, attaching an elastic membrane 114 to the upper portion, and then forming a space over the elastic membrane 114.

Furthermore, in performing maintenance of the inkjet head, a large quantity of ink may be purged with a high pressure, and the high pressure used in the purging can cause the elastic membrane 114 to be torn.

### SUMMARY

An aspect of the invention is to provide an inkjet head and a method of manufacturing the inkjet head, in which the membrane of the pressure absorbing space is formed in an integrated manner when processing the boards for manufacturing the inkjet head, so that the manufacturing process can be simplified, and in which the pressure absorbing space is equipped in the direction of a side wall of the manifold, so that pressure changes in the manifold can be absorbed more easily.

Another aspect of the invention is to provide an inkjet head and a method of manufacturing the inkjet head, in which the membrane is prevented from excessive deformation that may occur due to the high pressure used during the maintenance of the inkjet head, so that the membrane is prevented from being damaged.

One aspect of the invention provides a method of manufacturing an inkjet head that includes: forming in a first board an inlet, which penetrates the first board and through which ink may flow in, and a pressure chamber, which is formed as a recess in a surface of the first board; forming in a second board a manifold, which is to be connected with the inlet, a pressure absorbing space, which is positioned adjacent to the manifold and partitioned by a membrane, and an ink channel, which penetrates the second board and which is to be connected with the pressure chamber; forming in a third board a nozzle, which is to be connected with the ink channel; and stacking in order and attaching the first board, the second board, and the third board.

In certain embodiments, the method can further include attaching a piezoelectric component on an upper portion of the pressure chamber of the first board, after stacking in order and attaching the first board, the second board, and the third board.

Protrusions can be formed on the surface of the pressure absorbing space that faces the membrane.

Forming the manifold, the pressure absorbing space, and the ink channel in the second board can include: coating a first photoresist on a surface of the second board; selectively removing the first photoresist in correspondence to positions where the manifold, the pressure absorbing space, and the ink channel are to be formed; etching the second board to form the manifold, the pressure absorbing space, and the ink channel; and removing the first photoresist remaining on the second board.

In certain embodiments, a restrictor may additionally be formed in the second board, where the restrictor can connect the pressure chamber and the manifold and provide a passage for the supply of ink, in which case forming the manifold, the pressure absorbing space, and the ink channel in the second board can further include: coating a second photoresist on a surface of the second board; selectively removing the second photoresist in correspondence to a position where the restrictor is to be formed; etching a portion of the second board in correspondence to the position where the restrictor is to be formed; and removing the second photoresist remaining on the second board.

The first, second, and third boards may be formed by processing silicon boards, and the attaching may be performed by silicon direct bonding.

Another aspect of the invention provides an inkjet head formed by stacking a first board, a second board, and a third board in order. The inkjet head includes: an inlet, which penetrates the first board and provides a passage for the inflow of ink; a pressure chamber, which is formed as a recess in a surface of the first board that faces the second board; a manifold, which penetrates the second board and which is connected with the inlet; a pressure absorbing space, which penetrates the second board and which is positioned adjacent to the manifold; and a nozzle, which is formed in the third board, is connected with the pressure chamber, and through which the ink may be ejected.

The inkjet head can further include a restrictor, which is formed in the second board and which connects one end of the pressure chamber with the manifold; and an ink channel, which penetrates the second board and which connects the other end of the pressure chamber with the nozzle. In addition, a piezoelectric component can further be included, which is coupled to a surface of the pressure chamber and configured to change a volume of the pressure chamber. Also, one or more protrusions can further be included, which are formed on a surface of the pressure absorbing space that faces the membrane.

A side wall of the manifold may include a membrane, with the manifold and the pressure absorbing space partitioned by the membrane.

Yet another aspect of the invention provides an inkjet head that includes: a nozzle, through which ink droplets may be ejected; a pressure chamber, connected with the nozzle; a manifold, connected with the pressure chamber and configured to supply ink to the pressure chamber; and a pressure absorbing space formed adjacent to a side wall of the manifold that absorbs changes in pressure of the manifold.

An inkjet head according to this aspect of the invention can further include an ink channel, which connects the nozzle and the pressure chamber; and a restrictor, which connects the pressure chamber and the manifold and which forms a passage for the supply of ink. Also, one or more protrusions can further be included, which are formed on a surface of the pressure absorbing space that faces the membrane. Also, a piezoelectric component can be included that is coupled to a surface of the pressure chamber and configured to change a volume of the pressure chamber.

A side wall of the manifold may include a membrane, and the manifold and the pressure absorbing space may be partitioned by the membrane.

There may be a plurality of nozzles, and the inkjet head may include a plurality of ink channels connected respectively with the plurality of nozzles; a plurality of pressure chambers connected respectively with the plurality of ink channels; a plurality of restrictors connected respectively with the plurality of pressure chambers; and a manifold which supplies ink to the plurality of pressure chambers via the plurality of restrictors, where the plurality of restrictors may form a row of restrictors in one direction, with the membrane formed in a position facing the row of restrictors.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of an inkjet head according to the related art.

FIG. 2 is a flowchart of a method of manufacturing an inkjet head according to a first disclosed embodiment of the invention.

FIG. 3, FIG. 4, FIG. 5, FIG. 6, FIG. 7, and FIG. 8 are cross-sectional views representing a flow diagram of a method of manufacturing a second board according to the first disclosed embodiment of the invention.

FIG. 9, FIG. 10, and FIG. 11 are cross-sectional views representing a flow diagram of a method of manufacturing an inkjet head according to the first disclosed embodiment of the invention.

FIG. 12 is a cross-sectional view of an inkjet head according to a second disclosed embodiment of the invention.

FIG. 13 is a cross-sectional view across line A-A′ of FIG. 12.

FIG. 14 is a cross-sectional view of an inkjet head according to a third disclosed embodiment of the invention.

FIG. 15 shows a portion of a cross-sectional view of an inkjet head according to a fourth disclosed embodiment of the invention.

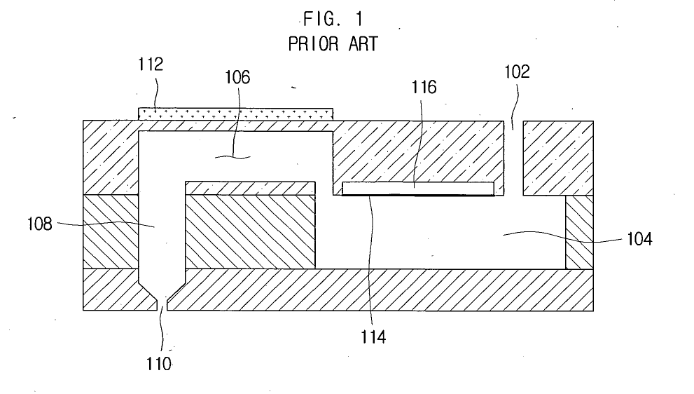

### DETAILED DESCRIPTION

As the invention allows for various changes and numerous embodiments, particular embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first,” “second,” etc., may be used to describe various components, such components must not be limited to the above terms. The above terms are used only to distinguish one component from another.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The inkjet head and method of manufacturing the inkjet head according to certain aspects of the invention will be described below in more detail with reference to the accompanying drawings, in which those components are rendered the same reference numeral that are the same or are in correspondence, regardless of the figure number, and redundant explanations are omitted.

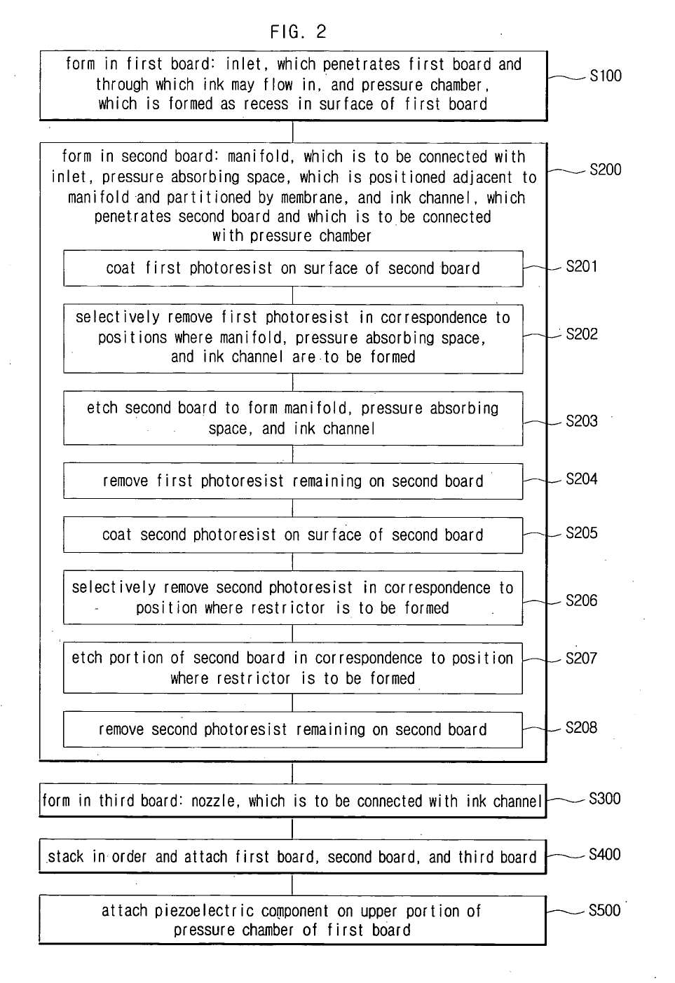

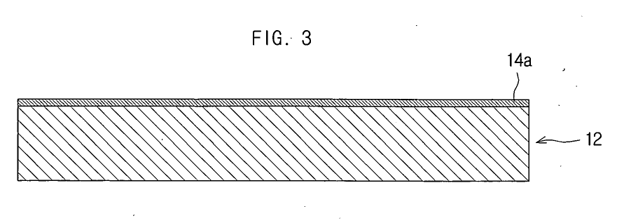

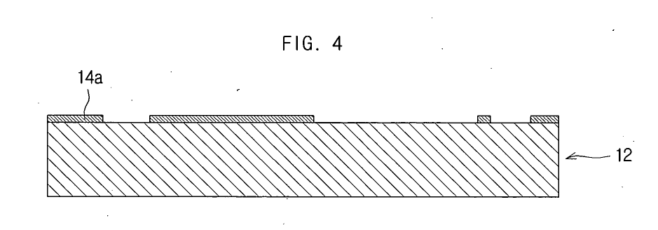

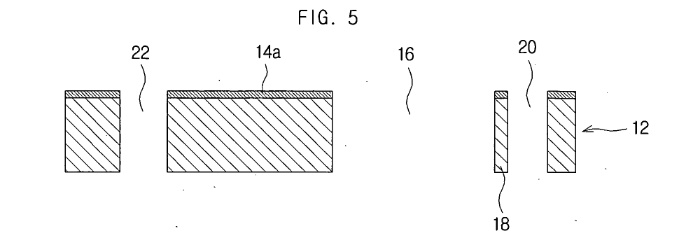

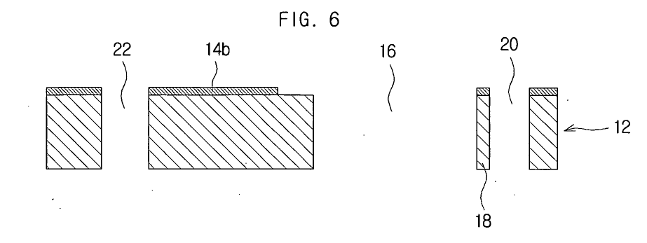

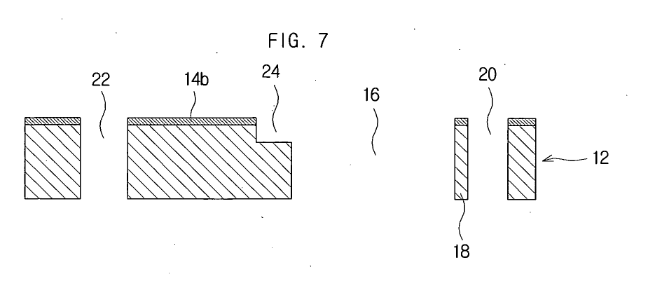

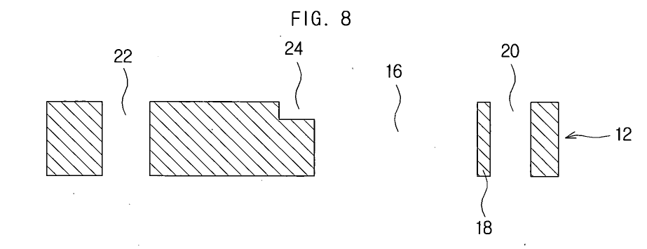

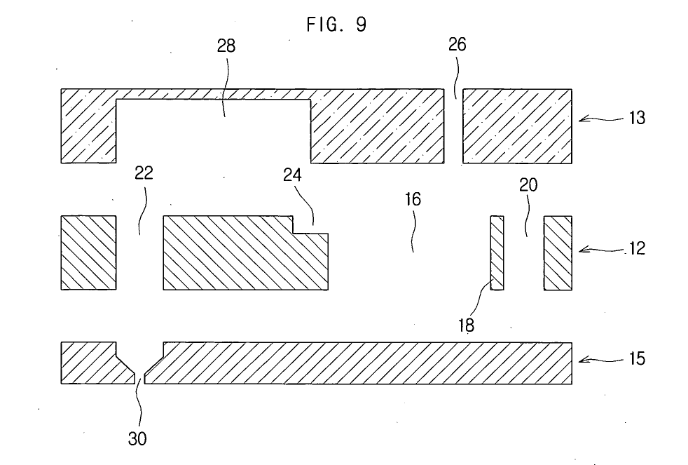

FIG. 2 is a flowchart of a method of manufacturing an inkjet head according to a first disclosed embodiment of the invention, and FIGS. 3 to 8 are cross-sectional views representing a flow diagram of a method of manufacturing a second board according to the first disclosed embodiment of the invention. FIGS. 9 to 11 are cross-sectional views representing a flow diagram of a method of manufacturing an inkjet head according to the first disclosed embodiment of the invention. In FIG. 3 to FIG. 11 are illustrated a second board 12, a first board 13, a photoresist 14a, 14b, a third board 15, a manifold 16, a membrane 18, a pressure absorbing space 20, an ink channel 22, a restrictor 24, an inlet 26, a pressure chamber 28, a nozzle 30, and a piezoelectric component 32.

A method of manufacturing an inkjet head according to this embodiment may include an operation of forming in a first board 13 an inlet 26, which penetrates the first board 13 and through which ink may flow in, and a pressure chamber 28, which is formed as a recess in a surface of the first board 13, an operation of forming in a second board 12 a manifold 16, which is to be connected with the inlet 26, a pressure absorbing space 20, which is positioned adjacent to the manifold 16 and partitioned by a membrane 18, and an ink channel 22, which penetrates the second board 12 and which is to be connected with the pressure chamber 28, an operation of forming in a third board 15 a nozzle 30, which is to be connected with the ink channel 22, and an operation of stacking the first board 13, the second board 12, and the third board 15 in order and attaching them together. Thus, the membrane 18 of the pressure absorbing space 20 can be formed in an integrated manner, when processing the boards for the manufacture of the inkjet head, to simplify the manufacturing process, and the pressure absorbing space 20 can be equipped in the direction of a side wall of the manifold 16, so that pressure changes in the manifold 16 can be absorbed more easily.

In this embodiment, three boards may be stacked in order and attached together to manufacture the inkjet head. First, as illustrated in the upper portion of FIG. 9, the inlet 26, which penetrates through the first board 13 and through which ink may flow in, as well as the pressure chamber 28, formed as a recess in a surface of the first board 13, can be formed in the first board 13 (S100).

The inlet 26 may be a passage that is connected to the reservoir (not shown), which supplies ink to the inkjet head, and thus the inlet 26 can be said to supply ink to the inkjet head. The pressure chamber 28 has the form of a recess in one surface of the first board 13, but when the first board 13 and second board 12 are attached together, the second board 12 covers a portion of the pressure chamber 28, so that the pressure chamber 28 may form a particular space. The upper portion of the pressure chamber 28 may have the form of a thin layer, such that the volume inside the pressure chamber 28 can be changed by the piezoelectric component 32 attached in a subsequent process.

One method of forming the pressure chamber 28 and the inlet 26 may include coating a photoresist on one surface of the first board 13 and afterwards removing the photoresist in correspondence to the positions where the pressure chamber 28 and the inlet 26 are to be formed. Then, in the position where the inlet 26 is to be formed, the first board 13 may be etched such that the first board 13 is penetrated, while in the position where the pressure chamber 28 is to be formed, a portion of the first board 13 may be etched, after which the photoresist remaining on the first board 13 can be removed.

The first board 13 may be made as a silicon board, and a straight etching process may be employed to etch the board to particular depths and form the inlet 26 and the pressure chamber 28. An example of a typical straight etching process is ICP-RIE (inductively coupled plasma reactive ion etching), but the invention is not thus limited.

Next, as illustrated in FIGS. 3 to 8, the manifold 16, which is to be connected with the inlet 26, the pressure absorbing space 20, which is positioned adjacent to the manifold 16 and partitioned by the membrane 18, and the ink channel 22, which is to be connected with the pressure chamber 28 and which penetrates the second board 12, can be formed in the second board 12 (S200). In this second board 12, a restrictor 24 may additionally be formed, which connects the pressure chamber 28 and the manifold 16, and which serves as a passage for the supply of ink.

Looking in more detail at a possible method for forming the manifold 16, pressure absorbing space 20, and ink channel 22 in the second board 12, first, as illustrated in FIG. 3, a photoresist 14a can be coated on a surface of the second board 12 (S201). Then, as illustrated in FIG. 4, the photoresist 14a can be selectively removed in correspondence to the positions where the manifold 16, pressure absorbing space 20, and ink channel 22 are to be formed (S202). In this case, in order that the manifold 16 and the pressure absorbing space 20 can be partitioned by the membrane 18, a portion of the photoresist 14a may be left between the manifold 16 and the pressure absorbing space 20 in correspondence with the desired thickness of the membrane 18. Thus, a membrane 18 having the same material as that of the second board 12 can be formed integrated with the second board 12, whereby the manufacturing process can be simplified. The membrane 18 can be made sufficiently thin such that it is able to elastically respond to changes in pressure of the manifold 16.

Next, as illustrated in FIG. 5, the second board 12 can be etched to form the manifold 16, pressure absorbing space 20, and ink channel 22, which penetrate the second board 12 (S203), and then the photoresist remaining on the second board 12 can be removed (S204). Here, the membrane 18 may be formed to have a low thickness by employing a type of dry etching, such as ICP-RIE mentioned above, which is performed in a substantially straight direction.

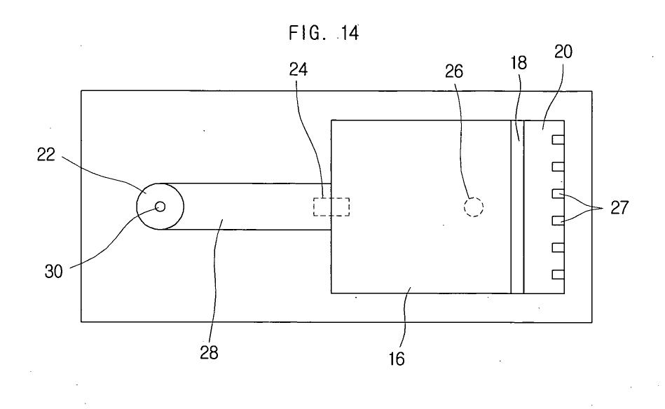

Protrusions can be formed on the surface of the pressure absorbing space 20 facing the membrane 18 (see FIG. 14). In maintenance procedures performed on the inkjet head, a large quantity of ink may be purged with a high pressure, and these protrusions prevent the membrane 18 from being damaged by deformation due to the high pressures used during the purging. That is, by placing one or more protrusions in particular intervals in relation to the membrane 18, the protrusions can prevent damage in the membrane 18, as the membrane 18 comes into contact with the protrusions when the membrane 18 is being deformed, such that the membrane 18 does not undergo excessive deformation.

In order to form such protrusions in the etching process of the second board 12, the photoresist can be left in positions corresponding to the protrusions on the surface of the pressure absorbing space 20 facing the membrane 18, whereby the protrusions can be formed in an integrated manner in the subsequent etching process.

On the other hand, in the case of forming a restrictor 24 in the second board 12 which connects the pressure chamber 28 and the manifold 16 and serves as a passage for supplying ink, a photoresist 14b can be coated on a surface of the second board 12, for example on the other surface of the second board 12 (S205), and then the photoresist 14b can be selectively removed in correspondence to the position where the restrictor 24 is to be formed (S206), as illustrated in FIG. 6. Then, as illustrated in FIG. 7, the restrictor 24 can be formed by etching a portion of the second board 12 in correspondence to the position where the restrictor 24 is to be formed (S207), and as illustrated in FIG. 8, the photoresist 14b remaining on the second board 12 can be removed (S208).

Next, as illustrated in the lower portion of FIG. 9, the nozzle 30, which is to be connected with the ink channel 22, can be formed in the third board 15 (S300). The nozzle 30 is where the ink is ejected according to the decrease in volume of the pressure chamber 28, and may be fabricated to have the form of a funnel, having a cone portion and an ejection outlet. In many cases, it is essential that the ink outlet of the nozzle 30 be made with precision and accuracy with regards its shape, including the cross-section and diameter, etc., and thus the ink outlet may advantageously be formed by dry etching, which provides a straight etching property, whereas a wet etching process may be employed to form the cone portion.

Next, as illustrated in FIG. 9 and FIG. 10, the first board 13, second board 12, and third board 15 processed as above can be stacked in order and attached together (S400). The first board 13 and second board 12 may be stacked together such that the inlet 26 of the first board 13 and the manifold 16 of the second board 12 are connected, one end of the pressure chamber 28 of the first board 13 and the manifold 16 or restrictor 24 of the second board 12 are connected, and the other end of the pressure chamber 28 of the first board 13 and the ink channel 22 of the second board 12 are connected. The second board 12 and the third board 15 may be stacked together such that the ink channel 22 of the second board 12 and the nozzle 30 of the third board 15 are connected.

The first board 13, second board 12, and third board 15 can be formed by processing silicon boards according to the methods described above.

If the first board 13, second board 12, and third board 15 are formed by processing silicon boards, each of the boards can be attached by silicon direct bonding, which is a technique of pressing under a high temperature, without having to use a separate bonding agent for the attachment.

Next, as illustrated in FIG. 11, the piezoelectric component 32 can be attached to the upper portion of the pressure chamber 28 of the first board 13 (S500). As described above, after fabricating each of the first board 13, second board 12, and third board 15, and then stacking these in order and attaching them together, a piezoelectric component 32 can be attached to an upper surface of the pressure chamber 28 of the first board 13, to manufacture a piezoelectric type inkjet head.

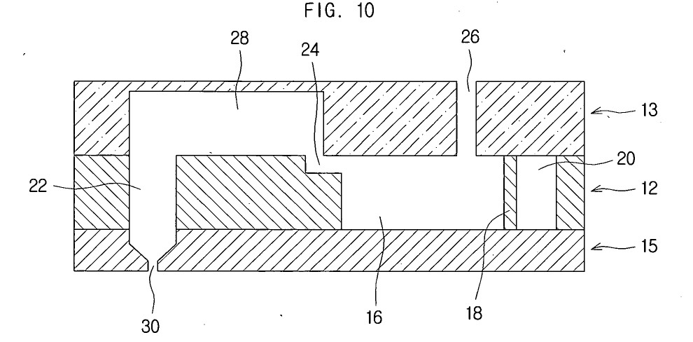

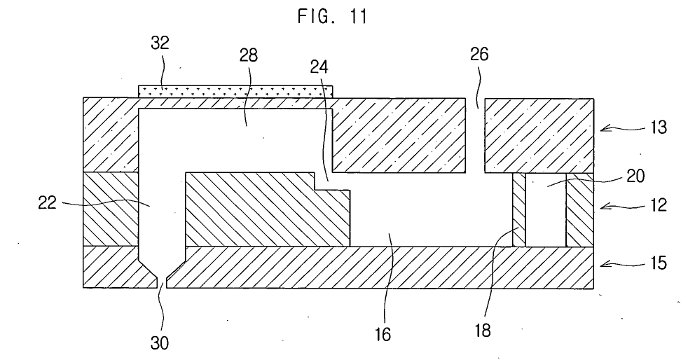

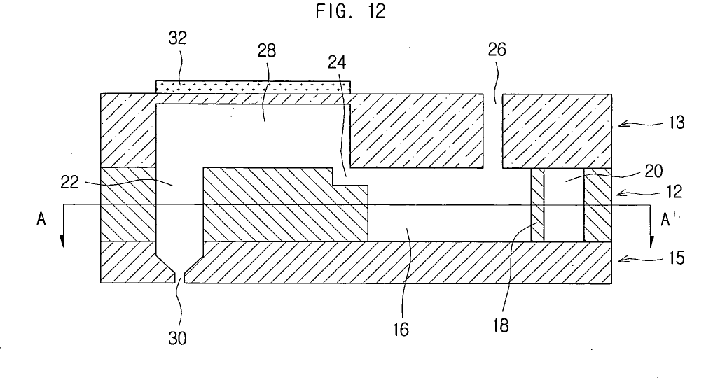

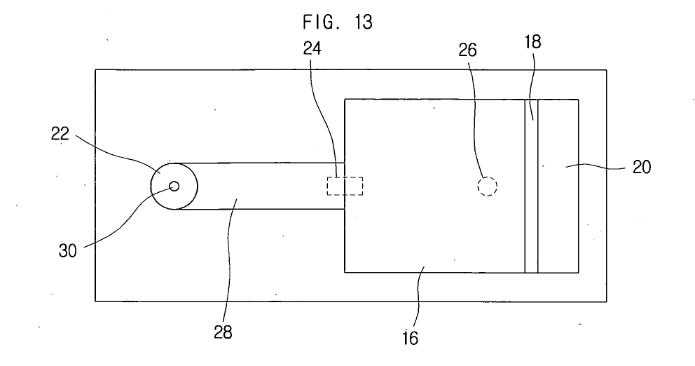

FIG. 12 is a cross-sectional view of an inkjet head according to a second disclosed embodiment of the invention, and FIG. 13 is a cross-sectional view across line A-A′ of FIG. 12. In FIGS. 12 and 13 are illustrated a second board 12, a first board 13, a third board 15, a manifold 16, a membrane 18, a pressure absorbing space 20, an ink channel 22, a restrictor 24, an inlet 26, a pressure chamber 28, a nozzle 30, and a piezoelectric component 32.

This embodiment relates to an inkjet head formed by stacking the first board 13, second board 12, and third board 15 in order. This inkjet head may be composed mainly of an inlet 26 penetrating the first board 13 through which ink may flow in, a pressure chamber 28 made as a recess in a surface of the first board 13 facing the second board 12, a manifold 16 penetrating the second board 12 and connected with the inlet 26, a pressure absorbing space 20 penetrating the second board 12 and formed adjacent to the manifold 16, and a nozzle 30 formed in the third board 15 which connects with the pressure chamber 28 and which ejects ink. The membrane 18 of the pressure absorbing space 20 can be formed in an integrated manner, when processing the boards for the manufacture of the inkjet head, to simplify the manufacturing process, and the pressure absorbing space 20 can be equipped in the direction of a side wall of the manifold 16, so that pressure changes in the manifold 16 can be absorbed more easily.

When the volume inside the pressure chamber 28 of the inkjet head is decreased for the ejection of the ink, the ink within the pressure chamber 28 may be ejected through the nozzle 30, while concurrently, the ink within the pressure chamber 28 may flow back into the manifold 16, and when the pressure chamber 28 is returned again to its original state, the ink inside the manifold 16 flows again to the pressure chamber 28 to fill the pressure chamber 28. The non-uniform pressure caused by such inflow and outflow of ink to and from the manifold 16 can lead to crosstalk between pressure chambers 28, which makes it difficult to obtain a consistent printing quality.

The inkjet head of this embodiment may be formed by stacking in order the first board 13, second board 12, and third board 15, where the pressure absorbing space 20 that absorbs pressure changes in the manifold 16 is placed adjacent to the manifold 16 of the second board 12, so that the pressure absorbing space 20 may absorb the non-uniform pressure within the manifold 16 and thus provide a consistent printing quality. In other words, the pressure absorbing space 20 may be formed adjacently in the direction towards a side wall of the manifold 16, so that the pressure absorbing space 20 may absorb the pressure caused by ink flowing into the manifold 16 as well as the pressure caused by ink flowing out of the manifold 16, thereby preventing crosstalk. In certain cases, as illustrated in FIG. 13, the pressure absorbing space 20 may advantageously be placed in a position facing a passage connecting the pressure chamber 28 and the manifold 16 (e.g. the entrance of the restrictor), in order that the pressure absorbing space 20 may directly absorb the pressure changes of the inflowing and outflowing ink of the pressure chamber 28.

A side wall of the manifold 16 can be given the form of a membrane 18, with the membrane 18 serving as a partition between the manifold 16 and the pressure absorbing space 20, such that the membrane 18 may undergo bending deformation due to the change in pressure of the manifold 16, while the pressure absorbing space 20 may absorb the change in pressure caused by the deformation of the membrane 18.

On the other hand, one protrusion or multiple protrusions may be formed on the surface of the pressure absorbing space 20 facing the membrane 18 that prevent the membrane 18 from excessive deformation, whereby the membrane 18 may be prevented from being torn by the high pressure used in purging during maintenance of the inkjet head (see FIG. 14).

A restrictor 24 may be formed in the second board 12 that connects one end of the pressure chamber 28 with the manifold 16, and an ink channel 22 may be formed in the second board 12 that penetrates the second board 12 to connect the other end of the pressure chamber 28 with the nozzle 30.

Furthermore, a piezoelectric component 32 which changes the volume of the pressure chamber 28 can be attached to a surface of the pressure chamber 28 of the first board 13.

When the first board 13, second board 12, and third board 15 are stacked in order and attached, the inlet 26 of the first board 13 and the manifold 16 of the second board 12 may be connected, one end of the pressure chamber 28 of the first board 13 and the manifold 16 or restrictor 24 of the second board 12 may be connected, and the other end of the pressure chamber 28 of the first board 13 and the ink channel 22 of the second board 12 may be connected. Also, the ink channel 22 of the second board 12 and the nozzle 30 of the third board 15 may be connected, whereby a passage is formed from the inlet 26 to the nozzle 30, through which the ink may move.

The inlet 26 is a passage which connects to the reservoir (not shown) for supplying ink to the inkjet head, and through which ink may be supplied to the inkjet head. The manifold 16 may be supplied with ink through the inlet 26 from the reservoir, and may supply the ink to the pressure chamber 28. An upper portion of the pressure chamber 28 can be given the form of a thin layer, so that by attaching the piezoelectric component 32 to the upper surface of the thin layer and applying an electrical vibration by way of the piezoelectric component 32, the volume of the pressure chamber 28 can be changed and ink may be ejected through the nozzle 30.

The ink channel 22, which connects the pressure chamber 28 with the nozzle 30, can serve as a damper that stabilizes the flow of ink.

As described above, the first board 13, second board 12, and third board 15, each endowed with the disclosed components, can be stacked and attached together to manufacture an inkjet head.

FIG. 14 is a cross-sectional view of an inkjet head according to a third disclosed embodiment of the invention. In FIG. 14 are illustrated a manifold 16, a membrane 18, a pressure absorbing space 20, an ink channel 22, a restrictor 24, an inlet 26, protrusions 27, a pressure chamber 28, and a nozzle 30.

At certain times during the use of an inkjet printer equipped with an inkjet head, a large quantity of ink is purged by a high pressure, for maintenance of the inkjet head, in order to remove impurities, such as ink residue remaining on the nozzle 30 of the inkjet head, etc., where damage may be inflicted, due to bending deformation, on the membrane 18 that partitions the manifold 16 and the pressure absorbing space 20. Therefore, this particular embodiment may be constructed with protrusions 27 formed on the surface of the pressure absorbing space 20 facing the membrane 18, to prevent excessive deformation of the membrane 18 and consequently prevent damage of the membrane 18.

This embodiment illustrates protrusions 27 shaped as pillars formed on the surface of the pressure absorbing space 20 facing the membrane 18. When thus forming the protrusions 27 in the shape of pillars, the protrusions 27 can readily be formed by the etching method described above, as pillar shapes on the pressure absorbing space 20. Of course, the protrusions 27 can be formed in any of various other shapes that prevent the membrane 18 from becoming excessively deformed.

Other elements of this embodiment are substantially the same as the corresponding elements of the first disclosed embodiment, and thus the descriptions thereof will not be repeated.

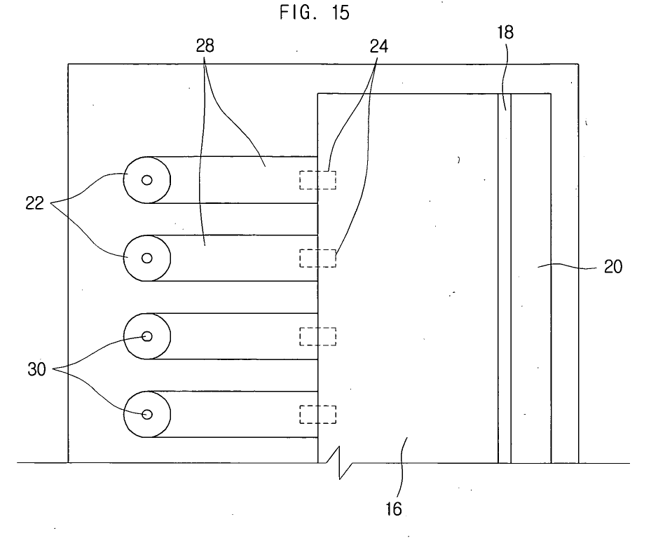

FIG. 15 shows a portion of a cross-sectional view of an inkjet head according to a fourth disclosed embodiment of the invention. In FIG. 15 are illustrated a manifold 16, a membrane 18, a pressure absorbing space 20, ink channels 22, restrictors 24, pressure chambers 28, and nozzles 30.

This embodiment relates to the case in which ink is supplied from one manifold 16 to a multiple number of pressure chambers 28. The inkjet head according to this embodiment may include a multiple number of nozzles 30, a multiple number of ink channels 22a each connected with the multiple number of nozzles 30, a multiple number of pressure chambers 28 each connected with the multiple number of ink channels 22, a multiple number of restrictors 24 each connected with the multiple number of pressure chambers 28, one manifold 16 that supplies ink through the multiple number of restrictors 24 to the multiple number of pressure chambers 28, and a pressure absorbing space 20 positioned adjacent to the manifold 16 and partitioned by the membrane 18, where the multiple number of restrictors 24 may form a row of restrictors 24 in one direction, with the membrane 18 formed facing the row of restrictors 24.

As such, the pressure absorbing space 20 can be made to directly absorb the pressure caused by ink flowing into or out of the manifold 16, by positioning the pressure absorbing space 20 adjacent to the manifold 16 in the direction of a side wall of the manifold 16, whereby crosstalk between the multiple number of pressure chambers 28 can be prevented.

That is, the membrane 18 can be located in a position facing the restrictor 24, which is the passage connecting the pressure chamber 28 and the manifold 16, allowing the pressure absorbing space 20 to directly absorb the pressure changes caused by the inflow and outflow of ink to and from the pressure chambers 28.

While it is not presented in this particular embodiment, the protrusions that prevent excessive deformation of the membrane 18 can be formed on the surface of the pressure absorbing space 20 opposite the membrane 18, to prevent the membrane 18 from being torn by the high pressure resulting from purging during the maintenance of the inkjet head.

Other elements of this embodiment are substantially the same as the corresponding elements of the first disclosed embodiment, and thus the descriptions thereof will not be repeated.

According to certain aspects of the invention as set forth above, the membrane of the pressure absorbing space may be formed in an integrated manner during the processing of the boards for manufacturing the inkjet head, so that the manufacturing process can be simplified. Also, the pressure absorbing space may be equipped in the direction of a side wall of the manifold, so that pressure changes in the manifold can be absorbed more easily. This can help prevent crosstalk between pressure chambers, to provide a higher printing quality.

Moreover, the reliability of the inkjet head can be increased, as the membrane can be prevented from bending deformation even under the high pressures used during the maintenance of the inkjet head.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A method of manufacturing an inkjet head, the method comprising:
forming an inlet and a pressure chamber in a first board, the inlet penetrating the first board and providing a passage for an inflow of ink, and the pressure chamber formed as a recess in a surface of the first board;
forming a manifold, a pressure absorbing space, and an ink channel in a second board, the manifold configured to be connected with the inlet, the pressure absorbing space positioned adjacent to the manifold and partitioned by a membrane, and the ink channel penetrating the second board and configured to be connected with the pressure chamber;
forming a nozzle in a third board, the nozzle configured to be connected with the ink channel; and
stacking in order and attaching the first board, the second board, and the third board.

2. The method of claim 1, further comprising, after the attaching:
attaching a piezoelectric component on an upper portion of the pressure chamber of the first board.

3. The method of claim 1, wherein at least one protrusion is formed on a surface of the pressure absorbing space facing the membrane.

4. The method of claim 1, wherein forming the manifold, the pressure absorbing space, and the ink channel in the second board comprises:
coating a first photoresist on a surface of the second board;
selectively removing the first photoresist in correspondence to positions where the manifold, the pressure absorbing space, and the ink channel are to be formed;
etching the second board to form the manifold, the pressure absorbing space, and the ink channel; and
removing the first photoresist remaining on the second board.

5. The method of claim 4, wherein a restrictor is further formed in the second board, the restrictor configured to connect the pressure chamber and the manifold and providing a passage for a supply of ink,
and forming the manifold, the pressure absorbing space, and the ink channel in the second board further comprises:
coating a second photoresist on a surface of the second board;
selectively removing the second photoresist in correspondence to a position where the restrictor is to be formed;
etching a portion of the second board in correspondence to the position where the restrictor is to be formed; and
removing the second photoresist remaining on the second board.

6. The method of claim 1, wherein the first board, the second board, and the third board are formed by processing silicon boards, and the attaching is performed by silicon direct bonding.

7. An inkjet head formed by stacking in order a first board, a second board, and a third board, the inkjet head comprising:
an inlet penetrating the first board and providing a passage for an inflow of ink;
a pressure chamber formed as a recess in a surface of the first board facing the second board;
a manifold penetrating the second board and connected with the inlet;
a pressure absorbing space penetrating the second board and positioned adjacent to the manifold; and
a nozzle formed in the third board, connected with the pressure chamber, and providing a passage for an ejection of the ink.

8. The inkjet head of claim 7, further comprising:
a restrictor formed in the second board and connecting one end of the pressure chamber with the manifold; and
an ink channel penetrating the second board and connecting the other end of the pressure chamber with the nozzle.

9. The inkjet head of claim 7, further comprising:
a piezoelectric component coupled to a surface of the pressure chamber and configured to change a volume of the pressure chamber.

10. The inkjet head of claim 7, wherein a side wall of the manifold includes a membrane, and the manifold and the pressure absorbing space are partitioned by the membrane.

11. The inkjet head of claim 10, further comprising:
a protrusion formed on a surface of the pressure absorbing space facing the membrane.

12. An inkjet head comprising:
a nozzle providing a passage for an ejection of an ink droplet;
a pressure chamber connected with the nozzle;
a manifold connected with the pressure chamber and configured to supply ink to the pressure chamber; and
a pressure absorbing space formed adjacent to a side wall of the manifold and configured to absorb a change in pressure of the manifold.

13. The inkjet head of claim 12, further comprising:
an ink channel connecting the nozzle and the pressure chamber; and
a restrictor connecting the pressure chamber and the manifold and forming a passage for a supply of ink.

14. The inkjet head of claim 12, further comprising:
a piezoelectric component coupled to a surface of the pressure chamber and configured to change a volume of the pressure chamber.

15. The inkjet head of claim 12, wherein a side wall of the manifold includes a membrane, and the manifold and the pressure absorbing space are partitioned by the membrane.

16. The inkjet head of claim 15, further comprising:
a protrusion formed on a surface of the pressure absorbing space facing the membrane.

17. The inkjet head of claim 15 having a plurality of nozzles, the inkjet head comprising:
a plurality of ink channels connected respectively with the plurality of nozzles;
a plurality of pressure chambers connected respectively with the plurality of ink channels;
a plurality of restrictors connected respectively with the plurality of pressure chambers; and
a manifold configured to supply ink to the plurality of pressure chambers via the plurality of restrictors,
wherein the plurality of restrictors form a row of restrictors in one direction, and the membrane is formed facing the row of restrictors.
